(19) United States
(12) Patent Application Publication
(10) Pub. No.: US 2025/0015858 A1
(43) Pub. Date: Jan. 9, 2025

(54) ADAPTIVE CHANNEL STATE INFORMATION (CSI) REPORT DEACTIVATION FOR BEAM PREDICTION

(71) Applicant: QUALCOMM Incorporated, San Diego, CA (US)

(72) Inventors: Qiaoyu LI, Beijing (CN); Arumugam CHENDAMARAI KANNAN, San Diego, CA (US); Yan ZHOU, San Diego, CA (US); Mahmoud TAHERZADEH BOROUJENI, San Diego, CA (US); Tao LUO, San Diego, CA (US); Tianyang BAI, Mountain View, CA (US); Yu ZHANG, San Diego, CA (US)

(21) Appl. No.: 18/707,805

(22) PCT Filed: Jan. 21, 2022
(86) PCT No.: PCT/CN2022/073102

§ 371 Date: May 6, 2024

(51) Int. Cl. H04B 7/06; H04W 72/21

(52) U.S. Cl. CPC H04B 7/0626; H04W 72/21

(57) ABSTRACT

Certain aspects of the present disclosure provide a method for wireless communications at a user equipment (UE). The UE determines whether to deactivate a semi-persistent (SP) channel state information (CSI) report associated with a first CSI report setting that is linked with a CSI report associated with a second CSI report setting. The second CSI report setting has a longer reporting periodicity than the first CSI report setting. The UE deactivates the SP CSI report, when at least the CSI report associated with the second CSI report setting is active.

### INTRODUCTION

Aspects of the present disclosure relate to wireless communications, and more particularly, to techniques for managing channel state information (CSI) reports.

Wireless communication systems are widely deployed to provide various telecommunication services such as telephony, video, data, messaging, broadcasts, or other similar types of services. These wireless communication systems may employ multiple-access technologies capable of supporting communication with multiple users by sharing available system resources with those users (e.g., bandwidth, transmit power, or other resources). Multiple-access technologies can rely on any of code division, time division, frequency division orthogonal frequency division, single-carrier frequency division, or time division synchronous code division, to name a few. These and other multiple access technologies have been adopted in various telecommunication standards to provide a common protocol that enables different wireless devices to communicate on a municipal, national, regional, and even global level.

Although wireless communication systems have made great technological advancements over many years, challenges still exist. For example, complex and dynamic environments can still attenuate or block signals between wireless transmitters and wireless receivers, undermining various established wireless channel measuring and reporting mechanisms, which are used to manage and optimize the use of finite wireless channel resources. Consequently, there exists a need for further improvements in wireless communications systems to overcome various challenges.

### SUMMARY

One aspect provides a method for wireless communications at a user equipment (UE), comprising: determining whether to deactivate a semi-persistent (SP) channel state information (CSI) report associated with a first CSI report setting that is linked with a CSI report associated with a second CSI report setting, wherein the second CSI report setting has a longer reporting periodicity than the first CSI report setting; and deactivating the SP CSI report, when at least the CSI report associated with the second CSI report setting is active.

Another aspect provides a method for wireless communications at a UE, comprising: detecting an uplink (UL) grant DCI triggering an aperiodic CSI report and activating a configured grant (CG) physical uplink shared channel (PUSCH); and sequentially outputting for transmission the aperiodic CSI report over multiple CG PUSCH transmission occasions, when at least one of a plurality of conditions is met.

Another aspect provides a method for wireless communications at a network entity, comprising: outputting for transmission to a UE an UL grant DCI triggering an aperiodic CSI report and activating a CG PUSCH; and sequentially obtaining from the UE the aperiodic CSI report over multiple CG PUSCH transmission occasions, when at least one of a plurality of conditions is met.

Other aspects provide: an apparatus operable, configured, or otherwise adapted to perform the aforementioned methods as well as those described elsewhere herein; a non-transitory, computer-readable media comprising instructions that, when executed by one or more processors of an apparatus, cause the apparatus to perform the aforementioned methods as well as those described elsewhere herein; a computer program product embodied on a computer-readable storage medium comprising code for performing the aforementioned methods as well as those described elsewhere herein; and an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF THE DRAWINGS

The appended figures depict certain features of the various aspects described herein and are not to be considered limiting of the scope of this disclosure.

FIG. 1 is a block diagram conceptually illustrating an example wireless communication network.

FIG. 2 is a block diagram conceptually illustrating aspects of an example base station (BS) and user equipment (UE).

FIGS. 3A-3D depict various example aspects of data structures for a wireless communication network.

FIG. 4 is a diagram illustrating example operations associated with beam measurement (BM).

FIGS. 5A and 5B illustrate an example of hierarchical beam refinement operations between a gNodeB (e.g., a gNB) and a UE.

FIG. 6A illustrates example BM cycles and synchronization signal block (SSB) indexes.

FIG. 6B illustrates example false alarm and misdetection rate of various schemes.

FIG. 7 illustrates example BM cycle based on false alarm and detected dynamic state.

FIG. 8 is a flow diagram illustrating example operations for wireless communication by a UE.

FIG. 9 illustrates example deactivation of semi-persistent (SP) channel state information (CSI) report associated with a first CSI report setting.

FIG. 10 illustrates example configuration of a CSI report timer associated with a first CSI report setting.

FIG. 11 illustrates example CSI report timer associated with a second CSI report setting.

FIG. 12 illustrates example configured grant (CG) physical uplink shared channel (PUSCH) activation based on an uplink (UL) grant downlink control information (DCI) activating an SP CSI report.

FIG. 13 is a flow diagram illustrating example operations for wireless communication by a UE.

FIG. 14 is a flow diagram illustrating example operations for wireless communication by a network entity.

FIG. 15 illustrates example CG PUSCH transmission occasions for reporting aperiodic CSI reports.

FIG. 16 illustrates example linking of different sub-configurations including a first CSI report setting, a second CSI report setting, and a CG PUSCH configuration.

FIG. 17 depicts aspects of an example communications device.

FIG. 18 depicts aspects of an example communications device.

FIG. 19 depicts aspects of an example communications device.

### DETAILED DESCRIPTION

Aspects of the present disclosure provide apparatuses, methods, processing systems, and computer-readable mediums for adaptively determining deactivation of a channel state information (CSI) report.

For example, in some beam measurement (BM) scenarios, there may be a lot of dynamic signaling (e.g., between a user equipment (UE) and a network entity) associated with requests for frequent semi-persistent (SP) CSI report activation/deactivation and/or triggering of aperiodic CSI report. This may cause a large signaling overhead. To reduce the signaling overhead, the UE may implicitly determine (without any signaling from the network entity) deactivation/release of an SP CSI report associated with a first CSI report setting, if a persistent (P)/SP CSI report associated with a second CSI report setting is active. The first CSI report setting is linked with the P/SP CSI report associated with the second CSI report setting (e.g., having a longer reporting periodicity than the first CSI report setting).

### Introduction to Wireless Communication Networks

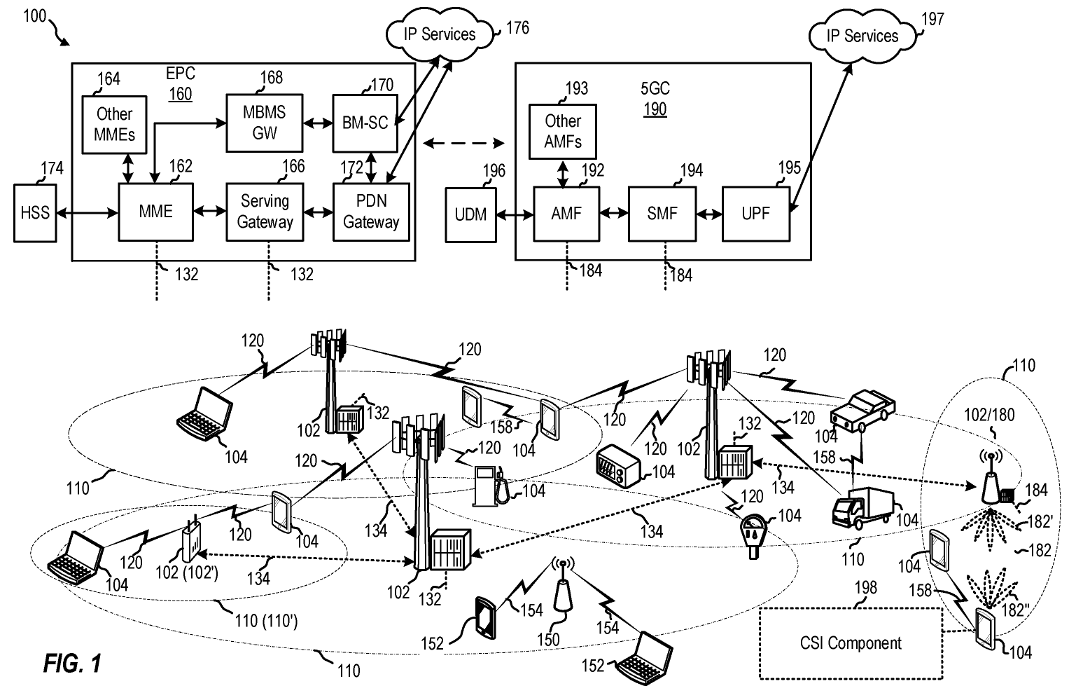

FIG. 1 depicts an example of a wireless communication network 100, in which aspects described herein may be implemented.

Generally, wireless communication network 100 includes base stations (BSs) 102, user equipments (UEs) 104, one or more core networks, such as an Evolved Packet Core (EPC) 160 and 5G Core (5GC) network 190, which interoperate to provide wireless communications services.

BSs 102 may provide an access point to the EPC 160 and/or 5GC 190 for a UE 104, and may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, delivery of warning messages, among other functions. BSs may include and/or be referred to as a gNB, NodeB, eNB, ng-eNB (e.g., an eNB that has been enhanced to provide connection to both EPC 160 and 5GC 190), an access point, a base transceiver station, a radio BS, a radio transceiver, or a transceiver function, or a transmission reception point in various contexts.

A BS, such as BS 102, may include components that are located at a single physical location or components located at various physical locations. In examples in which the BS includes components that are located at various physical locations, the various components may each perform various functions such that, collectively, the various components achieve functionality that is similar to a BS that is located at a single physical location. As such, a BS may equivalently refer to a standalone BS or a BS including components that are located at various physical locations or virtualized locations. In some implementations, a BS including components that are located at various physical locations may be referred to as or may be associated with a disaggregated radio access network (RAN) architecture, such as an Open RAN (O-RAN) or Virtualized RAN (VRAN) architecture. In some implementations, such components of a BS may include or refer to one or more of a central unit (CU), a distributed unit (DU), or a radio unit (RU).

BSs 102 wirelessly communicate with UEs 104 via communications links 120. Each of BSs 102 may provide communication coverage for a respective geographic coverage area 110, which may overlap in some cases. For example, small cell 102′ (e.g., a low-power BS) may have a coverage area 110′ that overlaps the coverage area 110 of one or more macrocells (e.g., high-power BSs).

The communication links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communication links 120 may use multiple-input and multiple-output (MIMO) antenna technology, including spatial multiplexing, beamforming, and/or transmit diversity in various aspects.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player, a camera, a game console, a tablet, a smart device, a wearable device, a vehicle, an electric meter, a gas pump, a large or small kitchen appliance, a healthcare device, an implant, a sensor/actuator, a display, or other similar devices. Some of UEs 104 may be internet of things (IoT) devices (e.g., parking meter, gas pump, toaster, vehicles, heart monitor, or other IoT devices), always on (AON) devices, or edge processing devices. UEs 104 may also be referred to more generally as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, or a client.

Communications using higher frequency bands may have higher path loss and a shorter range compared to lower frequency communications. Accordingly, certain BSs (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming.

In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

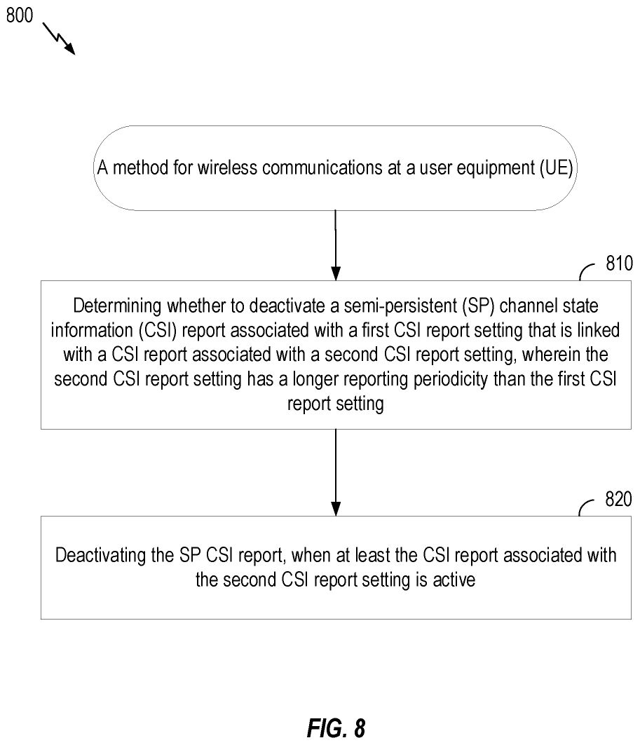

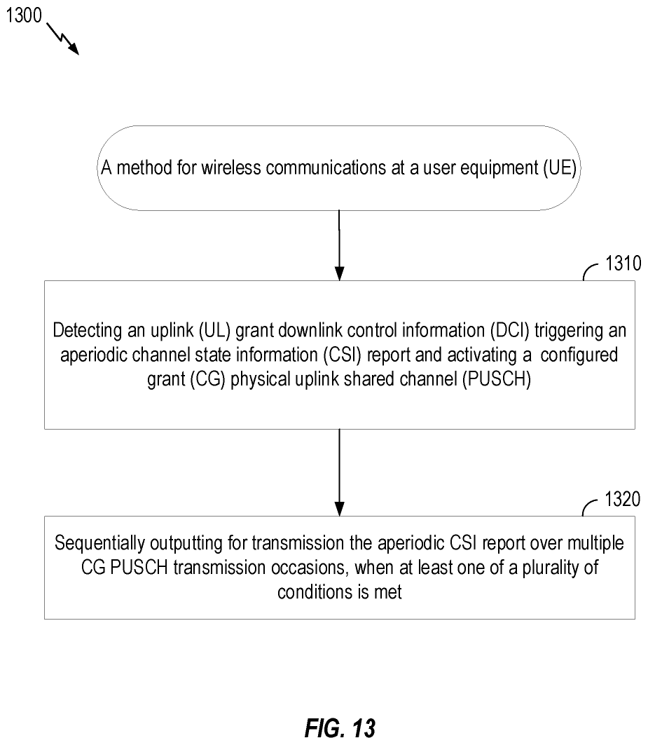

Wireless communication network 100 further includes channel state information (CSI) component 198, which may be used configured to perform operations 800 of FIG. 8 and operations 1300 of FIG. 13.

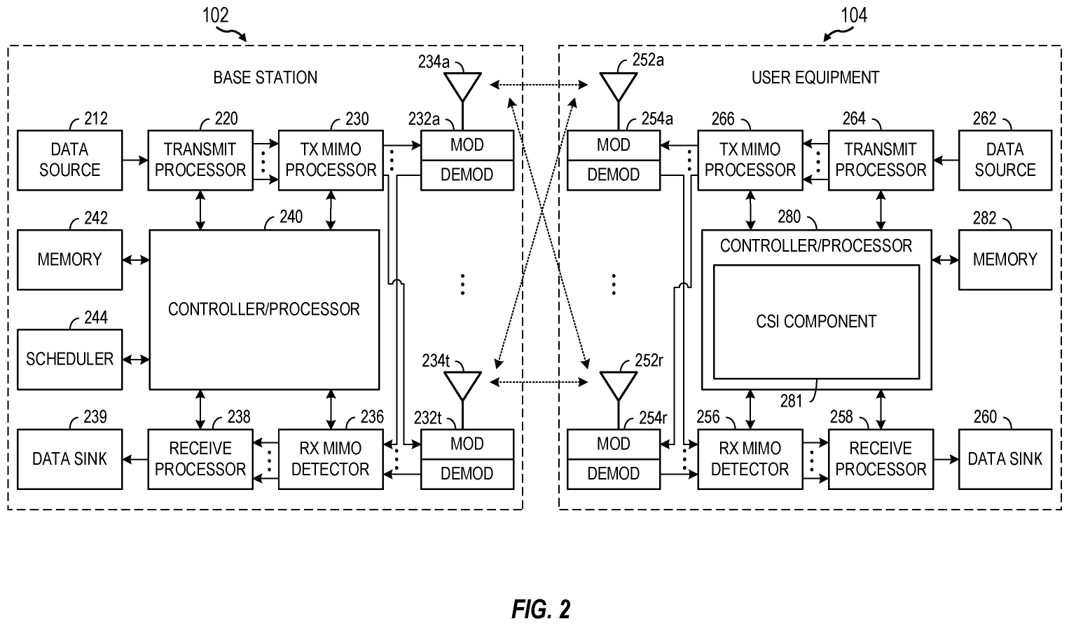

FIG. 2 depicts aspects of an example BS 102 and a UE 104. Generally, BS 102 includes various processors (e.g., 220, 230, 238, and 240), antennas 234a-t (collectively 234), transceivers 232a-t (collectively 232), which include modulators and demodulators, and other aspects, which enable wireless transmission of data (e.g., data source 212) and wireless reception of data (e.g., data sink 239). For example, BS 102 may send and receive data between itself and UE 104.

BS 102 includes controller/processor 240, which may be configured to implement various functions related to wireless communications.

Generally, UE 104 includes various processors (e.g., 258, 264, 266, and 280), antennas 252a-r (collectively 252), transceivers 254a-r (collectively 254), which include modulators and demodulators, and other aspects, which enable wireless transmission of data (e.g., data source 262) and wireless reception of data (e.g., data sink 260).

UE 104 includes controller/processor 280, which may be configured to implement various functions related to wireless communications. In the depicted example, controller/processor 280 includes CSI component 281, which may be representative of CSI component 198 of FIG. 1. Notably, while depicted as an aspect of controller/processor 280, CSI component 281 may be implemented additionally or alternatively in various other aspects of UE 104 in other implementations.

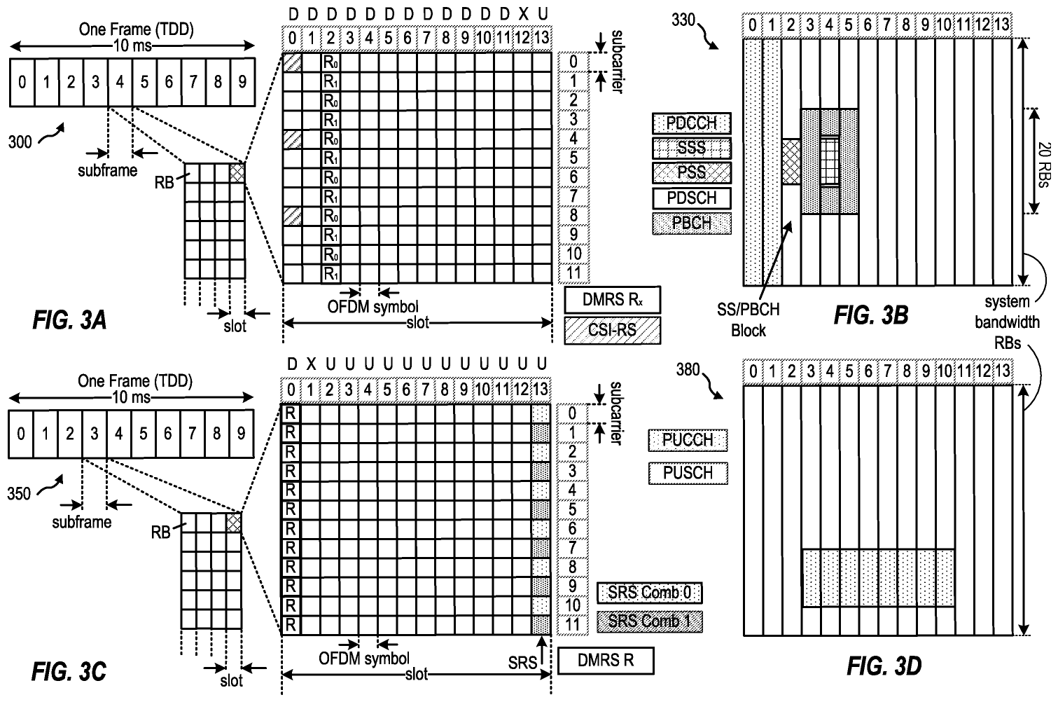

FIGS. 3A, 3B, 3C, and 3D depict aspects of data structures for a wireless communication network, such as wireless communication network 100 of FIG. 1. In particular, FIG. 3A is a diagram 300 illustrating an example of a first subframe within a 5G (e.g., 5G NR) frame structure, FIG. 3B is a diagram 330 illustrating an example of DL channels within a 5G subframe, FIG. 3C is a diagram 350 illustrating an example of a second subframe within a 5G frame structure, and FIG. 3D is a diagram 380 illustrating an example of UL channels within a 5G subframe.

Further discussions regarding FIG. 1, FIG. 2, and FIGS. 3A, 3B, 3C, and 3D are provided later in this disclosure.

Introduction to mmWave Wireless Communications

In wireless communications, an electromagnetic spectrum is often subdivided into various classes, bands, channels, or other features. The subdivision is often provided based on wavelength and frequency, where frequency may also be referred to as a carrier, a subcarrier, a frequency channel, a tone, or a subband.

5^{th} generation (5G) networks may utilize several frequency ranges, which in some cases are defined by a standard, such as 3rd generation partnership project (3GPP) standards. For example, 3GPP technical standard TS 38.101 currently defines Frequency Range 1 (FR1) as including 600 MHz-6 GHz, though specific uplink and downlink allocations may fall outside of this general range. Thus, FR1 is often referred to (interchangeably) as a “Sub-6 GHz” band.

Similarly, TS 38.101 currently defines Frequency Range 2 (FR2) as including 26-41 GHz, though again specific uplink and downlink allocations may fall outside of this general range. FR2, is sometimes referred to (interchangeably) as a “millimeter wave” (“mmW” or “mmWave”) band, despite being different from the extremely high frequency (EHF) band (30 GHz-300 GHz) that is identified by the International Telecommunications Union (ITU) as a “millimeter wave” band because wavelengths at these frequencies are between 1 millimeter and 10 millimeters.

Communications using mm Wave/near mmWave radio frequency band (e.g., 3 GHz-300 GHz) may have higher path loss and a shorter range compared to lower frequency communications. As described above with respect to FIG. 1, a base station (BS) (e.g., BS 180) configured to communicate using mmWave/near mmWave radio frequency bands may utilize beamforming (e.g., 182) with a user equipment (UE) (e.g., UE 104) to improve path loss and range.

### Example Beam Measurement

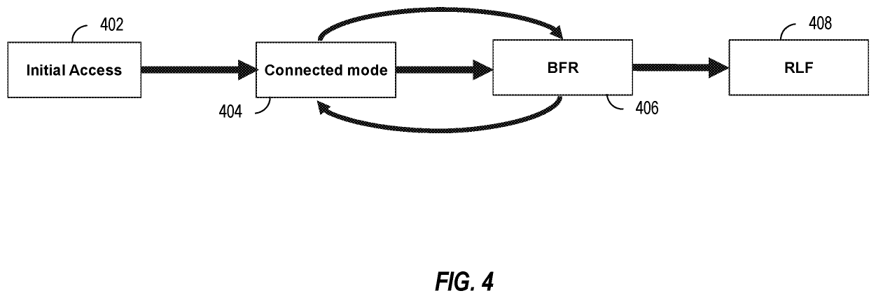

In wireless communications, various procedures may be performed for beam measurement. FIG. 4 is a diagram illustrating example operations where the beam measurement may be performed. In an initial access 402, a network entity sweeps through several beams (e.g., via synchronization signal blocks (SSBs)). The network entity configures a user equipment (UE) with random access channel (RACH) resources associated with beamformed SSBs to facilitate the initial access via the RACH resources. In certain aspects, an SSB may have a wider beam shape compared to other reference signals (RSs), such as a channel state information (CSI)-RS.

In a connected mode 404, the network entity and the UE may perform hierarchical beam refinement including beam selection (e.g., a process referred to as P1), beam refinement for a transmitter (e.g., a process referred to as P2), and beam refinement for a receiver (e.g., a process referred to as P3). In beam selection (P1), the network entity sweeps through the beams and the UE reports the beam with best channel properties. In beam refinement for the transmitter (P2), the network entity sweeps through narrower beams, and the UE reports the beam with the best channel properties among the narrow beams. In beam refinement for the receiver (P3), the network entity transmits using the same beam repeatedly, and the UE refines spatial reception parameters (e.g., a spatial filter) for receiving signals from the network entity via the beam. In certain aspects, the network entity and the UE may perform complementary procedures (e.g., U1, U2, and U3) for uplink beam measurement.

In certain cases where a beam failure occurs (e.g., due to beam misalignment and/or blockage), the UE performs a beam failure recovery (BFR) procedure 406, which may allow the UE to return to the connected mode 404 without performing a radio link failure (RLF) procedure 408. For example, the UE may be configured with candidate beams for the BFR. In response to detecting a beam failure, the UE requests the network entity to perform the BFR via one of the candidate beams (e.g., one of the candidate beams with a reference signal received power (RSRP) above a certain threshold). In certain cases where the RLF occurs, the UE performs the RLF procedure 408 to recover from the RLF, such as a RACH procedure.

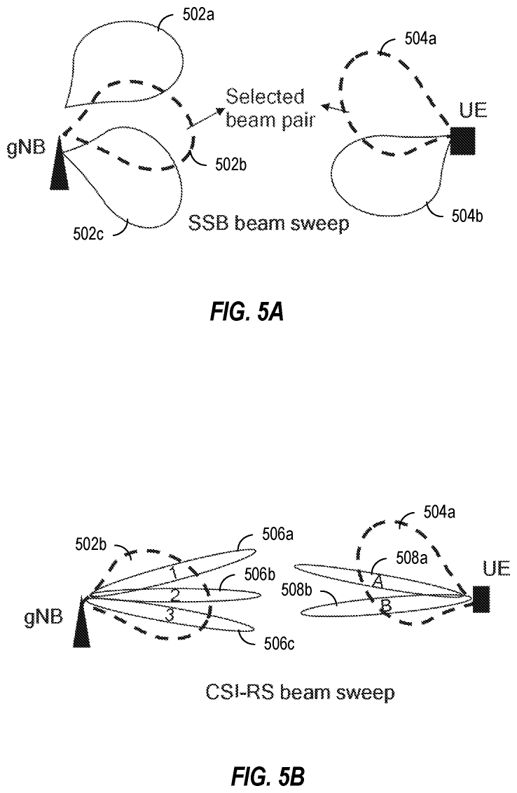

FIGS. 5A and 5B illustrate an example of hierarchical beam refinement operations between a gNodeB (gNB) and a UE. Referring to FIG. 5A, the gNB beam sweeps through certain RSs (e.g., SSBs), for example, with transmit beams 502a-c, and the UE selects a receive beam 504a associated with a particular SSB among receive beams 504a, 504b. For example, the SSB with the best channel properties measured at the UE may be selected.

Referring to FIG. 5B, the gNB refines a beam selection by sweeping through narrower beams 506a-c (e.g., CSI-RSs) within a selected SSB with a transmit beam 502b. The UE reports channel properties associated with a subset of the narrower beams, for example, beams 508a, 508b at the UE, which may correspond to the beams 506b, 506c at the gNB. The UE refines the receive beam selection by adjusting spatial reception parameters.

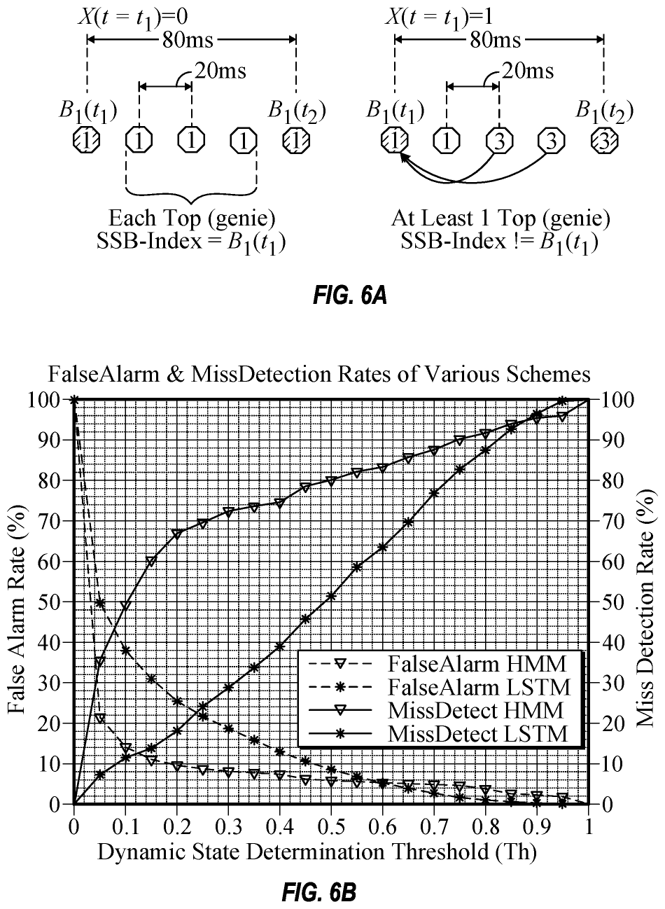

As illustrated in FIG. 6A, a first beam measurement (BM) cycle may be equal to 80 ms. In some cases, a gNB may determine SSB-index change between BM occasions (e.g. B₁(t₁) and B₂(t₂)) of the first BM cycle. For example, B₁(t): a top SSB-index at BM occasion t; t₁/t₂: a current/next BM occasion. The gNB uses the first BM cycle (instead of a second BM cycle (e.g., 20 ms)) while implementing a beam prediction technique (e.g., via UE reported SSB-index reference signal receive power (RSRP)) to perform the beam prediction. In some cases, when the gNB may predict a dynamic state (i.e., beams between the BM occasions may have changed relative to observed beams at the BM occasions), the gNB may dynamically alter a BM cycle (e.g., move from the first BM cycle to the second BM cycle).

In some cases, an artificial intelligence (AI) based model can be used to predict a future top beam index or a probability of future top beam change. One or more schemes such as a hidden markov model (HMM), a convolutional neural network (CNN), and/or a recurrent neural network (RNN) (e.g., long short-term memory (LSTM) or gated recurrent units (GRU)) may be implemented to predict the future top beam index or the probability of future top beam change. FIG. 6B illustrates false alarm and misdetection rates of the various schemes predicting the future top beam index or the probability of future top beam change. As illustrated in FIG. 6B, for a HMM scheme: (false alarm rate, misdetection rate) is equal to {78%, 10%}, {60%, 20%}, {19%, 40%} and for a LSTM scheme: (false alarm rate, misdetection rate) is equal to {42%, 10%}, {24%, 20%}, {13%, 40%}.

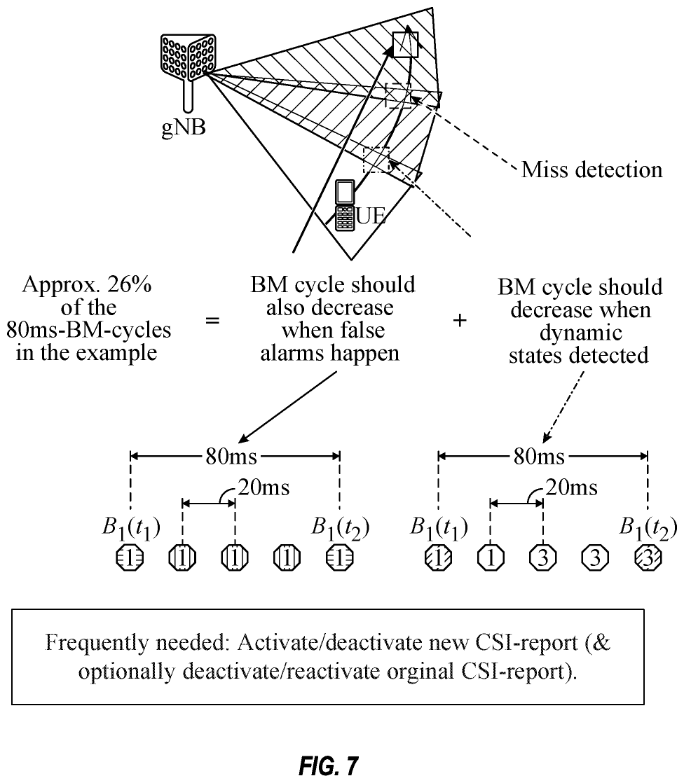

In some cases, aperiodic/semi-persistent (SP) channel state information (CSI) report with a shorter BM cycle (e.g., the second BM cycle) than a constantly used BM cycle (e.g., the first BM cycle) is needed for some BM cycles (e.g., for 26% of the first BM cycles). This may be due to false alarmed and detected dynamic states (e.g., as false alarm probability (FAP) and missed detection probability (MDP) are trade-offs) based on the above-noted schemes. For example, as illustrated in FIG. 7, while using a LSTM scheme for beam prediction, when MDP is equal to 24% (e.g., for a good link performance), then a corresponding FAP is equal to 22%. This translates to FAP+MDP*Pr(X(t)=1)=24%+2.3%*(1-22%)=26% of the first BM cycles (that should fall back to the second BM cycles for the beam prediction). In such cases, there are requests for frequent SP CSI report activation/deactivation and/or triggering of aperiodic CSI report, which may cause a large signaling overhead (e.g., due to a lot of dynamic signaling between the UE and the gNB).

### Aspects Related to Adaptive CSI Report Deactivation for Beam Prediction

Aspects of the present disclosure provide apparatuses, methods, processing systems, and computer-readable mediums for adaptively determining deactivation of a channel state information (CSI) report to reduce signaling overhead.

For example, a user equipment (UE) may implicitly determine (without any signaling from a network entity) deactivation/release of a semi-persistent (SP) CSI report associated with a first CSI report setting, if a persistent (P)/SP CSI report associated with a second CSI report setting is active. The first CSI report setting is linked with the P/SP CSI report associated with the second CSI report setting (e.g., having a longer reporting periodicity than the first CSI report setting).

FIG. 8 illustrates example operations 800 for wireless communication. The operations 800 may be performed, for example, by a UE (e.g., such as UE 104 in wireless communication network 100 of FIG. 1). The operations 800 may be implemented as software components that are executed and run on one or more processors (e.g., controller/processor 280 of FIG. 2). Further, transmission and reception of signals by the UE in the operations 800 may be enabled, for example, by one or more antennas (e.g., antennas 252 of FIG. 2). In certain aspects, the transmission and/or reception of signals by the UE may be implemented via a bus interface of one or more processors (e.g., the controller/processor 280) obtaining and/or outputting signals.

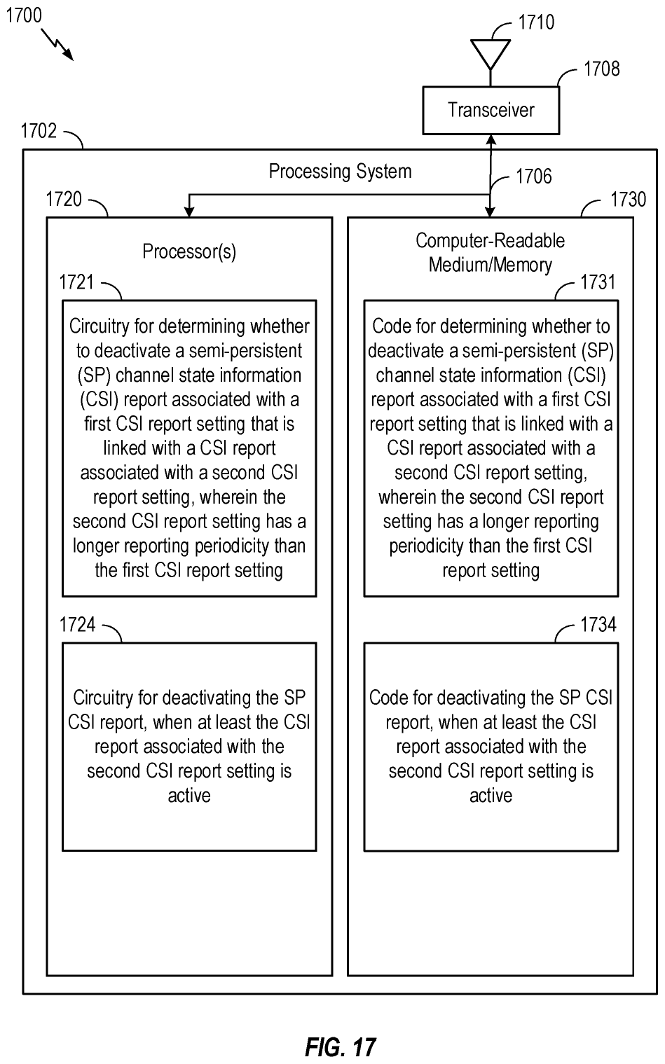

The operations 800 begin, at 810, by determining whether to deactivate an SP CSI report associated with a first CSI report setting that is linked with a CSI report associated with a second CSI report setting. The second CSI report setting has a longer reporting periodicity than the first CSI report setting. For example, the UE may determine whether to deactivate the SP CSI report using a processor of UE 104 shown in FIG. 1 or FIG. 2 and/or of the apparatus shown in FIG. 17.

At 820, the UE deactivates the SP CSI report, when at least the CSI report associated with the second CSI report setting is active. For example, the UE may deactivate the SP CSI report using a processor of UE 104 shown in FIG. 1 or FIG. 2 and/or of the apparatus shown in FIG. 17.

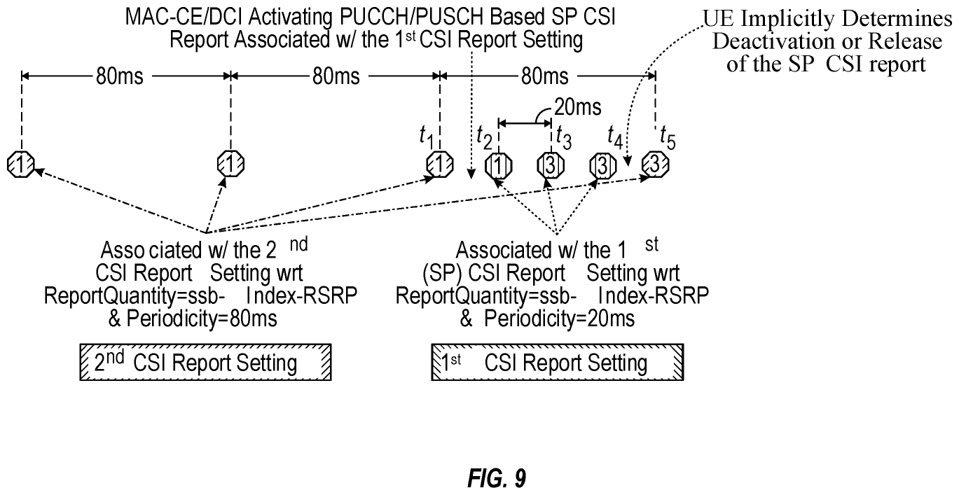

The operations shown in FIG. 8 may be understood with reference to the FIGS. 9-12.

As illustrated in FIG. 9, a first CSI report setting is associated with a first reporting periodicity (e.g., 20 ms) and a second CSI report setting is associated with a second reporting periodicity (e.g., 80 ms). Accordingly, the second CSI report setting has the longer reporting periodicity than the first CSI report setting. In such cases, a UE implicitly determines to deactivate an SP CSI report associated with the first CSI report setting, if a CSI report associated with the second report setting is active. In one example, the SP CSI report associated with the first CSI report setting is a medium access control (MAC) control element (CE) activated CSI report. In another example, the SP CSI report associated with the first CSI report setting is a downlink control information (DCI) triggered CSI report.

In certain aspects, the deactivation of the SP CSI report is independent of a MAC-CE or a DCI. For example, the UE may not expect to receive the DCI or the MAC-CE deactivating or releasing the SP CSI report.

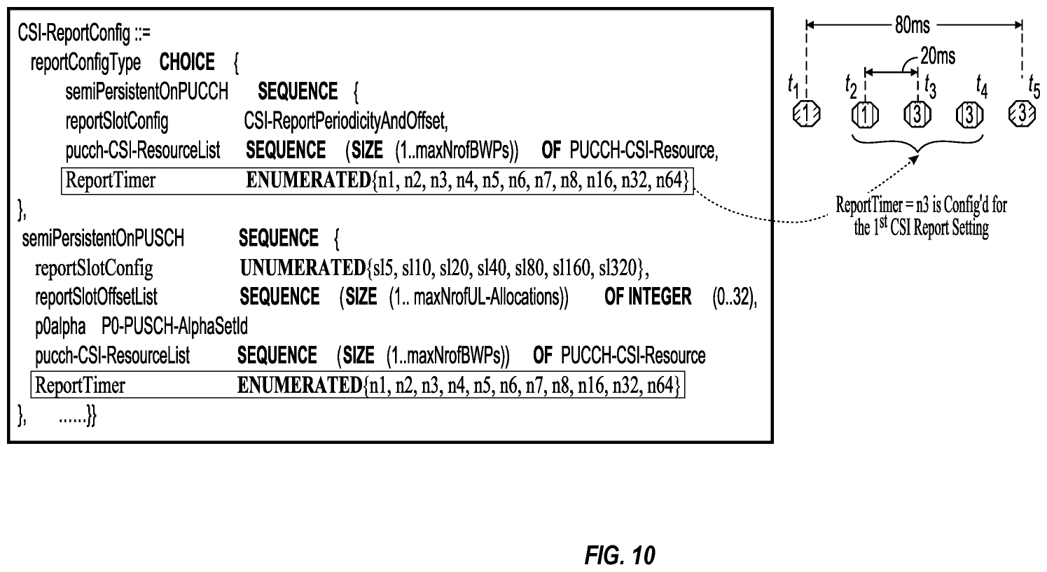

In certain aspects, the UE deactivates the SP CSI report associated with the first CSI report setting based on a value of a CSI report timer associated with the first CSI report setting. For example, as illustrated in FIG. 10, the deactivation of the SP CSI report is based on the values of the CSI report timer, in terms of reporting periodicities associated with the first CSI report setting (e.g., n1, n2, n4, n8, etc.). In one example, one or more values of the CSI report timer are radio resource control (RRC) preconfigured. In another example, a MAC CE activating the SP CSI report on a physical uplink control channel (PUCCH) indicates to the UE one of the one or more values of the CSI report timer. In another example, an UL grant DCI activating the SP CSI report on a physical uplink shared channel (PUSCH) indicates to the UE one of the one or more values of the CSI report timer.

In certain aspects, the UE deactivates the SP CSI report associated with the first CSI report setting based on a value of a CSI report timer associated with the first CSI report setting and the second CSI report setting (e.g., in terms of reporting periodicities associated with the first CSI report setting (e.g., n1, n2, n4, n8, etc.)). In one example, one or more values of the CSI report timer are RRC preconfigured. In another example, a MAC CE activating the SP CSI report on a PUCCH indicates to the UE one of the one or more values of the CSI report timer. In another example, an UL grant DCI activating the SP CSI report on a PUSCH indicates to the UE one of the one or more values of the CSI report timer.

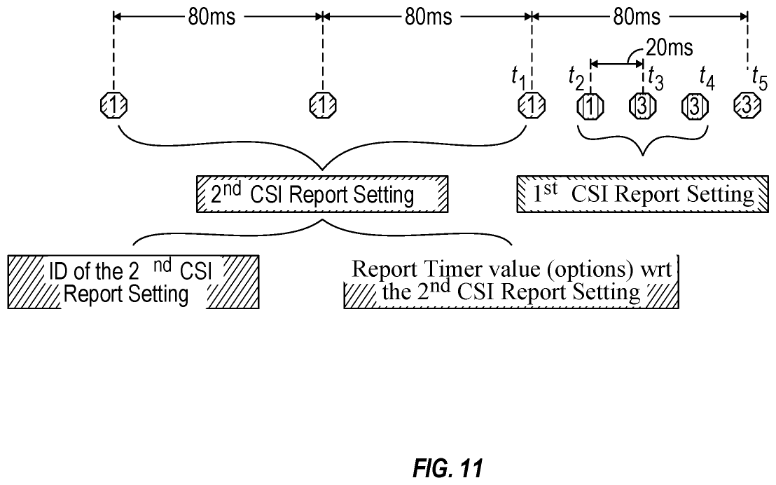

In certain aspects, one or more values of a CSI report timer are associated with the second CSI report setting. For example, as illustrated in FIG. 11, RRC configured CSI report timer value(s) are associated with the second CSI report setting, while the first CSI report setting is linked with the second CSI report setting (e.g., by including ID of the second CSI report setting within the second CSI report setting).

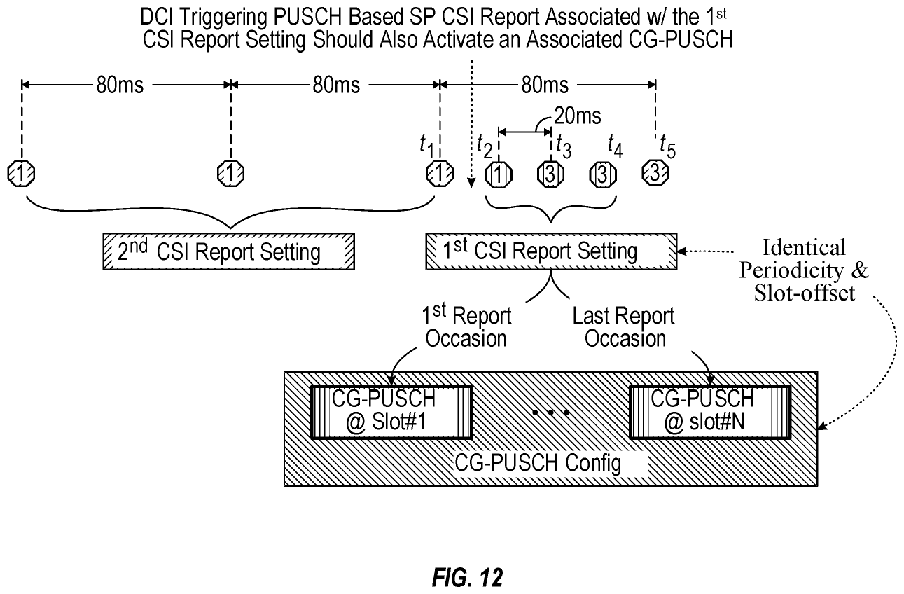

In certain aspects, the UE determines that the UL grant DCI activating the SP CSI report on the PUSCH further activates a configured grant (CG) PUSCH. For example, as illustrated in FIG. 12, for the first CSI report setting associated with the SP CSI report on the PUSCH, the UE expects the UL grant DCI to trigger a type-2 CG-PUSCH configuration.

As further illustrated in FIG. 12, a starting and ending SP CSI report slot is same as the CG PUSCH starting and ending slot (e.g., determined based on a CG time associated with the CG PUSCH), and the CG PUSCH has an identical periodicity and a slot-offset as the first CSI report setting.

In certain aspects, the UE determines a first reporting slot for the SP CSI report based on periodicities associated with the first CSI report setting and the second CSI report setting. In some cases, the UE may determine that a periodicity configured for the second CSI report setting may be divided by a periodicity configured for the first CSI report setting. In some cases, the UE may determine that a time difference between a slot configured for the first CSI report setting that is closest to an applicable slot configured for the second CSI report setting, may be equal to the periodicity configured for the first CSI report setting.

In certain aspects, the UE determines a last transmission occasion for the SP CSI report is based on the second CSI report setting. In one example, the last transmission occasion for the SP CSI report may be determined based on a last slot that does not overlap or is not after a slot including a next applicable transmission occasion for the CSI report associated with the second CSI report setting. In another example, the last transmission occasion for the SP CSI report may be determined based on the last slot that is determined based on RRC configurations associated with a certain transmission occasion of the CSI report associated with the second CSI report setting.

In certain aspects, the UE determines to refrain from transmitting the SP CSI report in a certain slot, based at least on the slot includes the CSI report associated with the second CSI report setting. For example, if the slot carrying a certain CSI report overlaps with the slot carrying the SP CSI report, the UE refrains from transmitting the SP CSI report.

In certain aspects, a priority of the SP CSI report being deactivated may be higher than a priority of other CSI reports, periodic CSI reports, SP CSI reports, and/or aperiodic CSI reports. In certain aspects, a priority of the SP CSI report being deactivated may be lower than a priority of other CSI reports, periodic CSI reports, SP CSI reports, and/or aperiodic CSI reports.

In certain aspects, a priority of the SP CSI report being deactivated may be higher than other CSI reports (e.g., when there is an overlap in time domain with other PUSCH). In certain aspects, a priority of the SP CSI report being deactivated may be lower than other CSI reports (e.g., since beam measurement cycles can be longer than other CSI feedback cycles).

In certain aspects, the UE executes an SP CSI report procedure when the SP CSI report associated with the first CSI report setting is triggered, and if at least the CSI report associated with the second CSI report setting is not triggered or released via an RRC. For example, the UE may determine to fall back to the SP CSI report procedure when the SP CSI report is activated/triggered, if the CSI report is not activated/triggered and/or the CG PUSCH is not activated in the same UL grant DCI triggering the SP CSI report.

### Aspects Related to Aperiodic CSI Reports

Aspects of the present disclosure provide apparatuses, methods, processing systems, and computer-readable mediums for managing aperiodic channel state information (CSI) reports. For example, uplink (UL) grant DCI triggers an aperiodic CSI report and activates a type-2 configured grant (CG) physical uplink shared channel (PUSCH) configuration, such that the aperiodic CSI report is sequentially reported over multiple CG PUSCH transmission occasions. The UE determines to receive the UL-grant DCI, if a persistent (P)/semi-persistent (SP) CSI report associated with a second CSI report setting is active.

FIG. 13 illustrates example operations 1300 for wireless communication. The operations 1300 may be performed, for example, by a UE (e.g., such as UE 104 in wireless communication network 100 of FIG. 1). The operations 1300 may be implemented as software components that are executed and run on one or more processors (e.g., controller/processor 280 of FIG. 2). Further, transmission and reception of signals by the UE in the operations 1300 may be enabled, for example, by one or more antennas (e.g., antennas 252 of FIG. 2). In certain aspects, the transmission and/or reception of signals by the UE may be implemented via a bus interface of one or more processors (e.g., the controller/processor 280) obtaining and/or outputting signals.

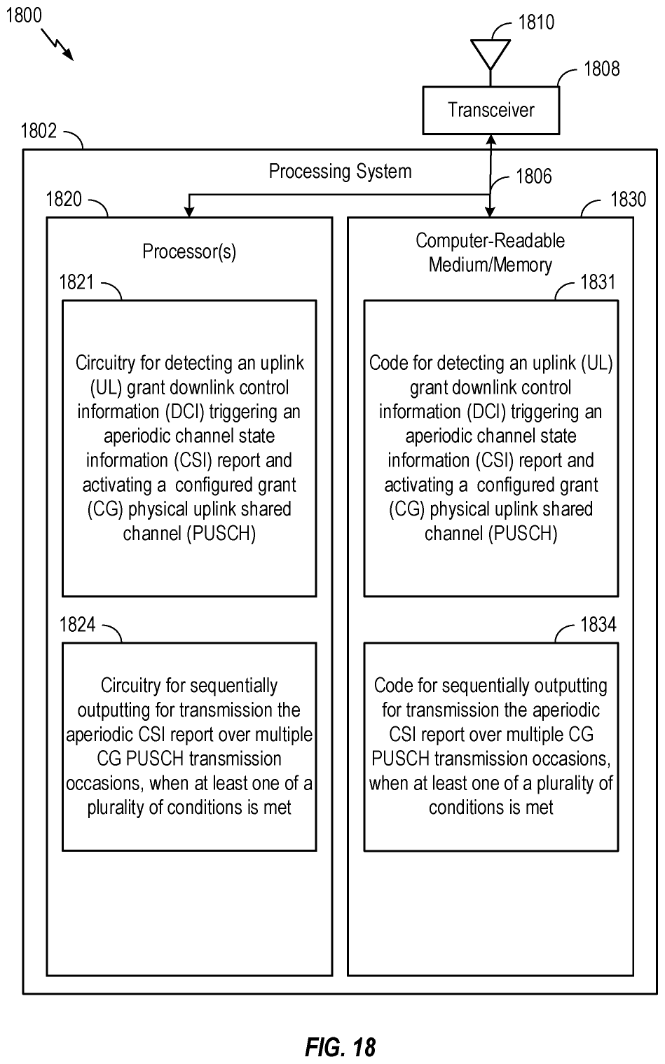

The operations 1300 begin, at 1310, by detecting an UL grant DCI triggering an aperiodic CSI report and activating a CG PUSCH. For example, the UE may detect the UL grant DCI using antenna(s) and/or receiver/transceiver components of UE 104 shown in FIG. 1 or FIG. 2 and/or of the apparatus shown in FIG. 18.

At 1320, the UE sequentially outputs for transmission the aperiodic CSI report over multiple CG PUSCH transmission occasions, when at least one of a plurality of conditions is met. For example, the UE may sequentially output for transmission the aperiodic CSI report using antenna(s) and/or transmitter/transceiver components of UE 104 shown in FIG. 1 or FIG. 2 and/or of the apparatus shown in FIG. 18.

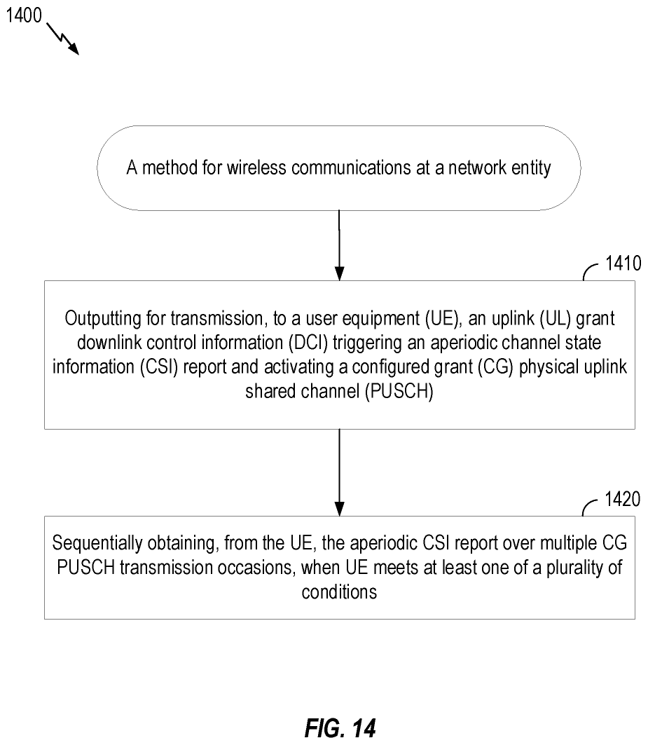

FIG. 14 illustrates example operations 1400 for wireless communication. The operations 1400 may be performed, for example, by a network entity (e.g., such as BS 102 in wireless communication network 100 of FIG. 1). The operations 1400 may be implemented as software components that are executed and run on one or more processors (e.g., controller/processor 240 of FIG. 2). Further, transmission and reception of signals by the network entity in the operations 1400 may be enabled, for example, by one or more antennas (e.g., antennas 234 of FIG. 2). In certain aspects, the transmission and/or reception of signals by the network entity may be implemented via a bus interface of one or more processors (e.g., the controller/processor 240) obtaining and/or outputting signals.

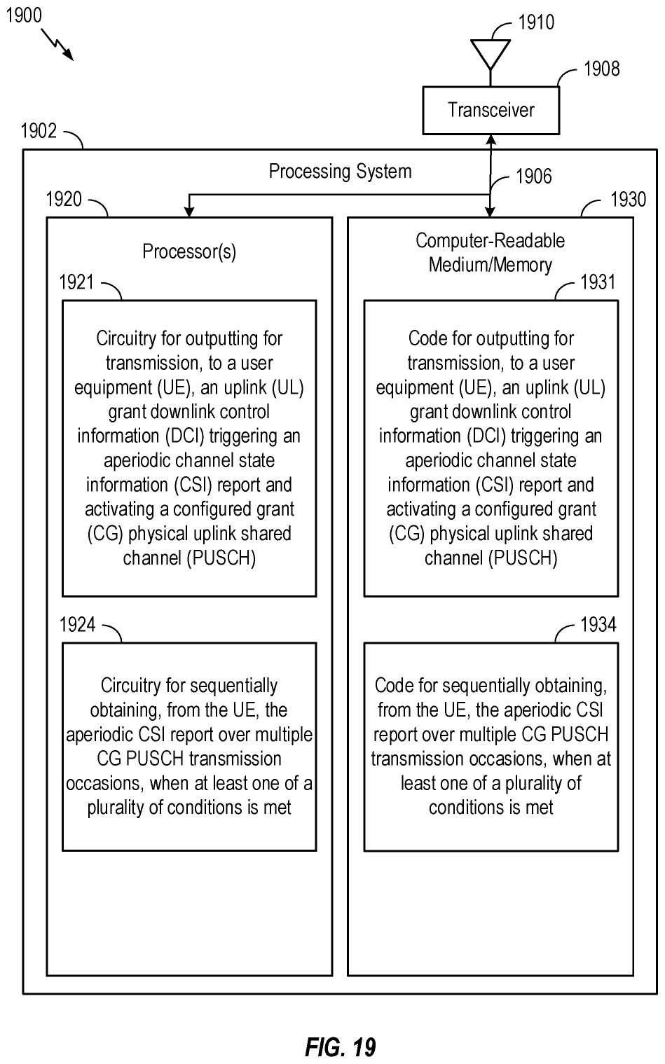

The operations 1400 begin, at 1410, by outputting for transmission to a UE an UL grant DCI triggering an aperiodic CSI report and activating a CG PUSCH. For example, the network entity may output for transmission the UL grant DCI to the UE using antenna(s) and/or transmitter/transceiver components of BS 102 shown in FIG. 1 or FIG. 2 and/or of the apparatus shown in FIG. 19.

At 1420, the network entity sequentially obtains from the UE the aperiodic CSI report over multiple CG PUSCH transmission occasions, when UE meets at least one of a plurality of conditions. For example, the network entity may obtain the aperiodic CSI report from the UE using antenna(s) and receiver/transceiver components of BS 102 shown in FIG. 1 or FIG. 2 and/or of the apparatus shown in FIG. 19.

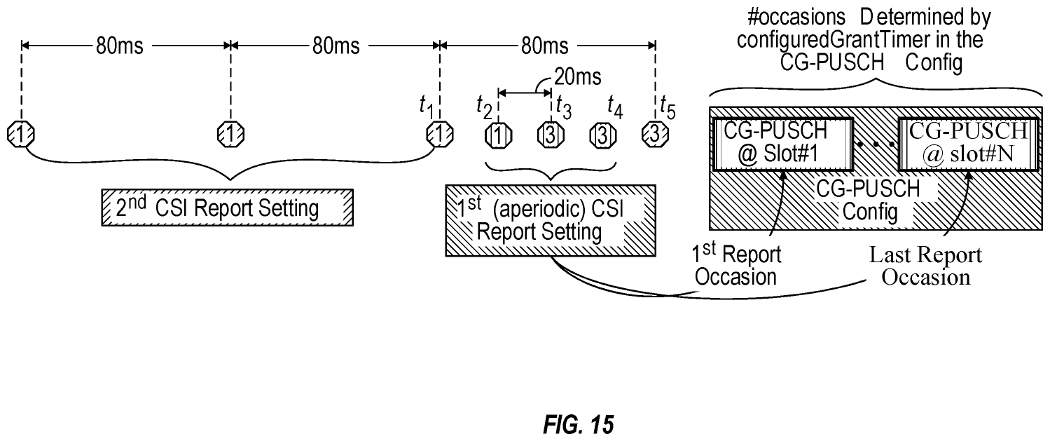

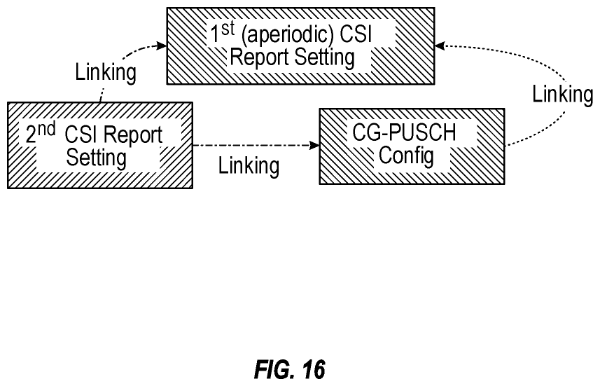

The operations shown in FIGS. 13-14 may be understood with reference to the FIGS. 15-16.

In certain aspects, a plurality of conditions may include a first condition indicating that the aperiodic CSI report is associated with a first CSI report setting that is linked with a CSI report associated with a second CSI report setting (e.g., second P/SP CSI report setting). The plurality of conditions may further include a second condition indicating that the aperiodic CSI report is associated with the CG PUSCH (e.g., type-2 CG PUSCH configuration). The plurality of conditions may further include a third condition indicating that the second CSI report setting is associated with the CG PUSCH. The plurality of conditions may further include a fourth condition indicating that a reporting periodicity of the CG PUSCH is less than a reporting periodicity of the second CSI report setting.

In certain aspects, the UE determines to receive signaling indicating the UL grant DCI, when the CSI report associated with the second CSI report setting is active.

In certain aspects, as illustrated in FIG. 15, the CG PUSCH transmission occasions for reporting the aperiodic CSI report are determined based on a CG PUSCH timer associated with the CG PUSCH configuration.

In certain aspects, as illustrated in FIG. 16, the aperiodic CSI report is based on one or more radio resource control (RRC) configurations linking at least one of a plurality of sub-configurations. The plurality of sub-configurations may include a first CSI report setting associated with the aperiodic CSI report, a second CSI report setting associated with a P/SP CSI report, and the CG PUSCH activated by the UL grant DCI. In some cases, linking of the sub-configurations is based on including ID of at least one of the sub-configuration in another sub-configuration.

In certain aspects, the UE executes an aperiodic CSI report procedure when the aperiodic CSI report (e.g., associated with the first CSI report setting) is triggered, if at least a CSI report (e.g., associated with the second CSI report setting) is not triggered or released via a RRC. For example, the UE may determine to fallback to the aperiodic CSI report procedure when the aperiodic CSI report is activated/triggered, if the CSI report is not activated/triggered and/or the CG PUSCH is not activated in the same UL grant DCI triggering the aperiodic CSI report.

### Example Wireless Communication Devices

FIG. 17 depicts an example communications device 1700 that includes various components operable, configured, or adapted to perform operations for the techniques disclosed herein, such as the operations depicted and described with respect to FIG. 8. In some examples, communication device 1700 may be a UE 104 as described, for example with respect to FIGS. 1 and 2.

Communications device 1700 includes a processing system 1702 coupled to a transceiver 1708 (e.g., a transmitter and/or a receiver). Transceiver 1708 is configured to transmit (or send) and receive signals for the communications device 1700 via an antenna 1710, such as the various signals as described herein. Processing system 1702 may be configured to perform processing functions for communications device 1700, including processing signals received and/or to be transmitted by communications device 1700.

Processing system 1702 includes one or more processors 1720 coupled to a computer-readable medium/memory 1730 via a bus 1706. In certain aspects, computer-readable medium/memory 1730 is configured to store instructions (e.g., computer-executable code) that when executed by the one or more processors 1720, cause the one or more processors 1720 to perform the operations illustrated in FIG. 8, or other operations for performing the various techniques discussed herein.

In the depicted example, computer-readable medium/memory 1730 stores code 1731 for determining whether to deactivate a semi-persistent (SP) channel state information (CSI) report associated with a first CSI report setting that is linked with a CSI report associated with a second CSI report setting where the second CSI report setting has a longer reporting periodicity than the first CSI report setting, and code 1734 for deactivating the SP CSI report when at least the CSI report associated with the second CSI report setting is active.

In the depicted example, the one or more processors 1720 include circuitry configured to implement the code stored in the computer-readable medium/memory 1730, including circuitry 1721 for determining whether to deactivate a semi-persistent SP CSI report associated with a first CSI report setting that is linked with a CSI report associated with a second CSI report setting where the second CSI report setting has a longer reporting periodicity than the first CSI report setting, and circuitry 1724 for deactivating the SP CSI report when at least the CSI report associated with the second CSI report setting is active.

Various components of communications device 1700 may provide means for performing the methods described herein, including with respect to FIG. 8.

In some examples, means for transmitting or sending (or means for outputting for transmission) may include the transceivers 254 and/or antenna(s) 252 of the UE 104 illustrated in FIG. 2 and/or transceiver 1708 and antenna 1710 of the communication device 1700 in FIG. 17.

In some examples, means for receiving (or means for obtaining) may include the transceivers 254 and/or antenna(s) 252 of the UE 104 illustrated in FIG. 2 and/or transceiver 1708 and antenna 1710 of the communication device 1700 in FIG. 17.

In some examples, means for determining whether to deactivate an SP CSI report associated with a first CSI report setting that is linked with a CSI report associated with a second CSI report setting where the second CSI report setting has a longer reporting periodicity than the first CSI report setting, and means for deactivating the SP CSI report when at least the CSI report associated with the second CSI report setting is active, may include various processing system components, such as: the one or more processors 1720 in FIG. 17, or aspects of the UE 104 depicted in FIG. 2, including receive processor 258, transmit processor 264, TX MIMO processor 266, and/or controller/processor 280 (including CSI component 281).

Notably, FIG. 17 is an example, and many other examples and configurations of communication device 1700 are possible.

FIG. 18 depicts an example communications device 1800 that includes various components operable, configured, or adapted to perform operations for the techniques disclosed herein, such as the operations depicted and described with respect to FIG. 13. In some examples, communication device 1800 may be a UE 104 as described, for example with respect to FIGS. 1 and 2.

Communications device 1800 includes a processing system 1802 coupled to a transceiver 1808 (e.g., a transmitter and/or a receiver). Transceiver 1808 is configured to transmit (or send) and receive signals for the communications device 1800 via an antenna 1810, such as the various signals as described herein. Processing system 1802 may be configured to perform processing functions for communications device 1800, including processing signals received and/or to be transmitted by communications device 1800.

Processing system 1802 includes one or more processors 1820 coupled to a computer-readable medium/memory 1830 via a bus 1806. In certain aspects, computer-readable medium/memory 1830 is configured to store instructions (e.g., computer-executable code) that when executed by the one or more processors 1820, cause the one or more processors 1820 to perform the operations illustrated in FIG. 13, or other operations for performing the various techniques discussed herein.

In the depicted example, computer-readable medium/memory 1830 stores code 1831 for detecting an uplink (UL) grant downlink control information (DCI) triggering an aperiodic channel state information (CSI) report and activating a configured grant (CG) physical uplink shared channel (PUSCH), and code 1834 for sequentially outputting for transmission the aperiodic CSI report over multiple CG PUSCH transmission occasions when at least one of a plurality of conditions is met.

In the depicted example, the one or more processors 1820 include circuitry configured to implement the code stored in the computer-readable medium/memory 1830, including circuitry 1821 for detecting an UL grant DCI triggering an aperiodic CSI report and activating a CG PUSCH, and circuitry 1824 for sequentially outputting for transmission the aperiodic CSI report over multiple CG PUSCH transmission occasions when at least one of a plurality of conditions is met.

Various components of communications device 1800 may provide means for performing the methods described herein, including with respect to FIG. 13.

In some examples, means for transmitting or sending (or means for outputting for transmission) may include the transceivers 254 and/or antenna(s) 252 of the UE 104 illustrated in FIG. 2 and/or transceiver 1808 and antenna 1810 of the communication device 1800 in FIG. 18.

In some examples, means for receiving (or means for obtaining) may include the transceivers 254 and/or antenna(s) 252 of the UE 104 illustrated in FIG. 2 and/or transceiver 1808 and antenna 1810 of the communication device 1800 in FIG. 18.

In some examples, means for detecting an UL grant DCI triggering an aperiodic CSI report and activating a CG PUSCH, and means for sequentially outputting for transmission the aperiodic CSI report over multiple CG PUSCH transmission occasions when at least one of a plurality of conditions is met, may include various processing system components, such as: the one or more processors 1820 in FIG. 18, or aspects of the UE 104 depicted in FIG. 2, including receive processor 258, transmit processor 264, TX MIMO processor 266, and/or controller/processor 280 (including CSI component 281).

Notably, FIG. 18 is an example, and many other examples and configurations of communication device 1800 are possible.

FIG. 19 depicts an example communications device 1900 that includes various components operable, configured, or adapted to perform operations for the techniques disclosed herein, such as the operations depicted and described with respect to FIG. 14. In some examples, communication device 1900 may be a BS 102 as described, for example with respect to FIGS. 1 and 2.

Communications device 1900 includes a processing system 1902 coupled to a transceiver 1908 (e.g., a transmitter and/or a receiver). Transceiver 1908 is configured to transmit (or send) and receive signals for the communications device 1900 via an antenna 1910, such as the various signals as described herein. Processing system 1902 may be configured to perform processing functions for communications device 1900, including processing signals received and/or to be transmitted by communications device 1900.

Processing system 1902 includes one or more processors 1920 coupled to a computer-readable medium/memory 1930 via a bus 1906. In certain aspects, computer-readable medium/memory 1930 is configured to store instructions (e.g., computer-executable code) that when executed by the one or more processors 1920, cause the one or more processors 1920 to perform the operations illustrated in FIG. 14, or other operations for performing the various techniques discussed herein.

In the depicted example, computer-readable medium/memory 1930 stores code 1931 for outputting for transmission to a UE an UL grant DCI triggering an aperiodic CSI report and activating a CG PUSCH, and code 1934 for sequentially obtaining from the UE the aperiodic CSI report over multiple CG PUSCH transmission occasions when at least one of a plurality of conditions is met.

In the depicted example, the one or more processors 1920 include circuitry configured to implement the code stored in the computer-readable medium/memory 1930, including circuitry 1921 for outputting for transmission to a UE an UL grant DCI triggering an aperiodic CSI report and activating a CG PUSCH, and circuitry 1924 for sequentially obtaining from the UE the aperiodic CSI report over multiple CG PUSCH transmission occasions when at least one of a plurality of conditions is met.

Various components of communications device 1900 may provide means for performing the methods described herein, including with respect to FIG. 14.

In some examples, means for transmitting or sending (or means for outputting for transmission) may include the transceivers 232 and/or antenna(s) 234 of the BS 102 illustrated in FIG. 2 and/or transceiver 1908 and antenna 1910 of the communication device 1900 in FIG. 19.

In some examples, means for receiving (or means for obtaining) may include the transceivers 232 and/or antenna(s) 234 of the BS illustrated in FIG. 2 and/or transceiver 1908 and antenna 1910 of the communication device 1900 in FIG. 19.

In some cases, rather than actually transmitting, for example, signals and/or data, a device may have an interface to output signals and/or data for transmission (a means for outputting). For example, a processor may output signals and/or data, via a bus interface, to a radio frequency (RF) front end for transmission. Similarly, rather than actually receiving signals and/or data, a device may have an interface to obtain the signals and/or data received from another device (a means for obtaining). For example, a processor may obtain (or receive) the signals and/or data, via a bus interface, from an RF front end for reception. In various aspects, an RF front end may include various components, including transmit and receive processors, transmit and receive MIMO processors, modulators, demodulators, and the like, such as depicted in the examples in FIG. 2.

In some examples, means for outputting for transmission to a UE an UL grant DCI triggering an aperiodic CSI report and activating a CG PUSCH, and means for sequentially obtaining from the UE the aperiodic CSI report over multiple CG PUSCH transmission occasions when at least one of a plurality of conditions is met, may include various processing system components, such as: the one or more processors 1920 in FIG. 19, or aspects of the BS 102 depicted in FIG. 2, including receive processor 238, transmit processor 220, TX MIMO processor 230, and/or controller/processor 240.

Notably, FIG. 19 is an example, and many other examples and configurations of communication device 1900 are possible.

### Example Aspects

Aspect 1: A method for wireless communication at a user equipment (UE), comprising: determining whether to deactivate a semi-persistent (SP) channel state information (CSI) report associated with a first CSI report setting that is linked with a CSI report associated with a second CSI report setting, wherein the second CSI report setting has a longer reporting periodicity than the first CSI report setting; and deactivating the SP CSI report, when at least the CSI report associated with the second CSI report setting is active.

Aspect 2: The method of aspect 1, wherein the SP CSI report associated with the first CSI report setting is a medium access control (MAC) control element (CE) activated CSI report or a downlink control information (DCI) triggered CSI report.

Aspect 3: The method of aspect 1, wherein the deactivation of the SP CSI report is independent of a medium access control (MAC) control element (CE) or a downlink control information (DCI).

Aspect 4: The method of aspect 1, wherein the SP CSI report associated with the first CSI report setting is deactivated based on a value of a CSI report timer associated with the first CSI report setting.

Aspect 5: The method of aspect 4, wherein the value of the CSI report timer is radio resource control (RRC) preconfigured.

Aspect 6: The method of aspect 4, wherein one or more values of the CSI report timer are radio resource control (RRC) preconfigured, and wherein a medium access control (MAC) control element (CE) activating the SP CSI report on a physical uplink control channel (PUCCH) indicates one of the one or more values.

Aspect 7: The method of aspect 4, wherein one or more values of the CSI report timer are radio resource control (RRC) preconfigured, and wherein an uplink (UL) grant downlink control information (DCI) activating the SP CSI report on a physical uplink shared channel (PUSCH) indicates one of the one or more values.

Aspect 8: The method of aspect 1, wherein the SP CSI report associated with the first CSI report setting is deactivated based on a value of a CSI report timer associated with the first CSI report setting and the second CSI report setting.

Aspect 9: The method of aspect 8, wherein the value of the CSI report timer is radio resource control (RRC) preconfigured.

Aspect 10: The method of aspect 8, wherein one or more values of the CSI report timer are radio resource control (RRC) preconfigured, and wherein a medium access control (MAC) control element (CE) activating the SP CSI report on a physical uplink control channel (PUCCH) indicates one of the one or more values.

Aspect 11: The method of aspect 8, wherein one or more values of the CSI report timer are radio resource control (RRC) preconfigured, and wherein an uplink (UL) grant downlink control information (DCI) activating the SP CSI report on a physical uplink shared channel (PUSCH) indicates one of the one or more values.

Aspect 12: The method of aspect 8, wherein one or more values of the CSI report timer are associated with the second CSI report setting.

Aspect 13: The method of aspect 1, further comprising determining that an uplink (UL) grant downlink control information (DCI) activating the SP CSI report on a physical uplink shared channel (PUSCH) further activates a configured grant (CG) PUSCH.

Aspect 14: The method of aspect 13, wherein: a starting and ending SP CSI report slot is same as a the CG PUSCH starting and ending slot, determined based on a CG time associated with the CG PUSCH; and the CG PUSCH has an identical periodicity and a slot-offset as the first CSI report setting.

Aspect 15: The method of aspect 1, further comprising determining a first reporting slot for the SP CSI report, based on periodicities associated with the first CSI report setting and the second CSI report setting.

Aspect 16: The method of aspect 1, further comprising determining a last transmission occasion for the SP CSI report based at least on the second CSI report setting, wherein the last transmission occasion for the SP CSI report is determined based on at least one of: a last slot at least does not overlap or is not after a slot comprising a next applicable transmission occasion for the CSI report associated with the second CSI report setting; or the last slot is determined based on radio resource control (RRC) configurations associated with a certain transmission occasion of the CSI report associated with the second CSI report setting; and determining to refrain from output for transmission the SP CSI report in a certain slot, based at least on the slot comprises the CSI report associated with the second CSI report setting.

Aspect 17: The method of aspect 1, wherein a priority of the SP CSI report being deactivated is either higher or lower than a priority of one or more of: periodic CSI reports, other SP CSI reports, and aperiodic CSI reports.

Aspect 18: The method of aspect 1, further comprising executing an SP CSI report procedure when a first SP CSI report is triggered, if at least a second SP CSI report is not triggered or released via a radio resource control (RRC).

Aspect 19: A method for wireless communication at a user equipment (UE), comprising: detecting an uplink (UL) grant downlink control information (DCI) triggering an aperiodic channel state information (CSI) report and activating a configured grant (CG) physical uplink shared channel (PUSCH); and sequentially outputting for transmission the aperiodic CSI report over multiple CG PUSCH transmission occasions, when at least one of a plurality of conditions is met.

Aspect 20: The method of aspect 19, wherein the plurality of conditions comprise at least one of: a first condition indicating that the aperiodic CSI report is associated with a first CSI report setting that is linked with a CSI report associated with a second CSI report setting, a second condition indicating that the aperiodic CSI report is associated with the CG PUSCH, a third condition indicating that the second CSI report setting is associated with the CG PUSCH, and a fourth condition indicating that a reporting periodicity of the CG PUSCH is less than a reporting periodicity of the second CSI report setting.

Aspect 21: The method of aspect 20, further comprising obtaining signaling comprising the UL grant DCI, when the CSI report associated with the second CSI report setting is active.

Aspect 22: The method of aspect 19, wherein the CG PUSCH transmission occasions for reporting the aperiodic CSI report are determined based on a CG PUSCH timer associated with the CG PUSCH.

Aspect 23: The method of aspect 19, wherein the aperiodic CSI report is based on one or more radio resource control (RRC) configurations linking at least one of a plurality of sub-configurations, wherein the plurality of sub-configurations comprise a first CSI report setting associated with the aperiodic CSI report, a second CSI report setting associated with a CSI report comprising a persistent or semi-persistent (SP) CSI report, and the CG PUSCH activated by the UL grant DCI.

Aspect 24: The method of aspect 19, further comprising executing an aperiodic CSI report procedure when a first aperiodic CSI report is triggered, if at least a second aperiodic CSI report is not triggered or released via a radio resource control (RRC).

Aspect 25: An apparatus for wireless communications, comprising: a memory comprising instructions; and one or more processors configured to execute the instructions and cause the apparatus to perform a method in accordance with any one of Aspects 1-18.

Aspect 26: An apparatus for wireless communications, comprising: a memory comprising instructions; and one or more processors configured to execute the instructions and cause the apparatus to perform a method in accordance with any one of Aspects 19-24.

Aspect 27: A user equipment (UE), comprising: at least one transceiver; a memory comprising instructions; and one or more processors configured to execute the instructions and cause the UE to perform a method in accordance with any one of Aspects 1-18, wherein the at least one transceiver is configured to receive a medium access control (MAC) control element (CE) activating the SP CSI report or a downlink control information (DCI) triggering the SP CSI report.

Aspect 28: A user equipment (UE), comprising: at least one transceiver; a memory comprising instructions; and one or more processors configured to execute the instructions and cause the UE to perform a method in accordance with any one of Aspects 19-24, wherein the at least one transceiver is configured to transmit the aperiodic CSI report.

Aspect 29: An apparatus for wireless communications, comprising means for performing a method in accordance with any one of Aspects 1-18.

Aspect 30: An apparatus for wireless communications, comprising means for performing a method in accordance with any one of Aspects 19-24.

Aspect 31: A non-transitory computer-readable medium comprising instructions that, when executed by an apparatus, cause the apparatus to perform a method in accordance with any one of Aspects 1-18.

Aspect 32: A non-transitory computer-readable medium comprising instructions that, when executed by an apparatus, cause the apparatus to perform a method in accordance with any one of Aspects 19-24.

### Additional Wireless Communication Network Considerations

The techniques and methods described herein may be used for various wireless communications networks (or wireless wide area network (WWAN)) and radio access technologies (RATs). While aspects may be described herein using terminology commonly associated with 3G, 4G, and/or 5G (e.g., 5G new radio (NR)) wireless technologies, aspects of the present disclosure may likewise be applicable to other communication systems and standards not explicitly mentioned herein.

5G wireless communication networks may support various advanced wireless communication services, such as enhanced mobile broadband (eMBB), millimeter wave (mmWave), machine type communications (MTC), and/or mission critical targeting ultra-reliable, low-latency communications (URLLC). These services, and others, may include latency and reliability requirements.

Returning to FIG. 1, various aspects of the present disclosure may be performed within the example wireless communication network 100.

In 3GPP, the term “cell” can refer to a coverage area of a NodeB and/or a narrowband subsystem serving this coverage area, depending on the context in which the term is used. In NR systems, the term “cell” and BS, next generation NodeB (gNB or gNodeB), access point (AP), distributed unit (DU), carrier, or transmission reception point may be used interchangeably. A BS may provide communication coverage for a macro cell, a pico cell, a femto cell, and/or other types of cells.

A macro cell may generally cover a relatively large geographic area (e.g., several kilometers in radius) and may allow unrestricted access by UEs with service subscription. A pico cell may cover a relatively small geographic area (e.g., a sports stadium) and may allow unrestricted access by UEs with service subscription. A femto cell may cover a relatively small geographic area (e.g., a home) and may allow restricted access by UEs having an association with the femto cell (e.g., UEs in a Closed Subscriber Group (CSG) and UEs for users in the home). A BS for a macro cell may be referred to as a macro BS. A BS for a pico cell may be referred to as a pico BS. A BS for a femto cell may be referred to as a femto BS, home BS, or a home NodeB.

BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface). Third backhaul links 134 may generally be wired or wireless.

Small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. Small cell 102′, employing NR in an unlicensed frequency spectrum, may boost coverage to and/or increase capacity of the access network.

Some base stations, such as BS 180 (e.g., gNB) may operate in a traditional sub-6 GHz spectrum, in millimeter wave (mmWave) frequencies, and/or near mmWave frequencies in communication with the UE 104. When the BS 180 operates in mmWave or near mm Wave frequencies, the BS 180 may be referred to as an mm Wave base station.

The communication links 120 between BSs 102 and, for example, UEs 104, may be through one or more carriers. For example, BSs 102 and UEs 104 may use spectrum up to Y MHz (e.g., 5, 10, 15, 20, 100, 400, and other MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Wireless communication network 100 further includes a Wi-Fi access point (AP) 150 in communication with Wi-Fi stations (STAs) 152 via communication links 154 in, for example, a 2.4 GHz and/or 5 GHz unlicensed frequency spectrum. When communicating in an unlicensed frequency spectrum, the STAs 152/AP 150 may perform a clear channel assessment (CCA) prior to communicating in order to determine whether the channel is available.

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, 4G (e.g., LTE), or 5G (e.g., NR), to name a few options.

EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to the IP Services 176, which may include, for example, the Internet, an intranet, an IP Multimedia Subsystem (IMS), a PS Streaming Service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and may be responsible for session management (start/stop) and for collecting eMBMS related charging information.

5GC 190 may include an Access and Mobility Management Function (AMF) 192, other AMFs 193, a Session Management Function (SMF) 194, and a User Plane Function (UPF) 195. AMF 192 may be in communication with a Unified Data Management (UDM) 196.

AMF 192 is generally the control node that processes the signaling between UEs 104 and 5GC 190. Generally, AMF 192 provides QoS flow and session management.

All user Internet protocol (IP) packets are transferred through UPF 195, which is connected to the IP Services 197, and which provides UE IP address allocation as well as other functions for 5GC 190. IP Services 197 may include, for example, the Internet, an intranet, an IP Multimedia Subsystem (IMS), a PS Streaming Service, and/or other IP services.

Returning to FIG. 2, various example components of BS 102 and UE 104 (e.g., the wireless communication network 100 of FIG. 1) are depicted, which may be used to implement aspects of the present disclosure.

At BS 102, a transmit processor 220 may receive data from a data source 212 and control information from a controller/processor 240. The control information may be for the physical broadcast channel (PBCH), physical control format indicator channel (PCFICH), physical hybrid ARQ indicator channel (PHICH), physical downlink control channel (PDCCH), group common PDCCH (GC PDCCH), and others. The data may be for the physical downlink shared channel (PDSCH), in some examples.

A medium access control (MAC)-control element (MAC-CE) is a MAC layer communication structure that may be used for control command exchange between wireless nodes. The MAC-CE may be carried in a shared channel such as a physical downlink shared channel (PDSCH), a physical uplink shared channel (PUSCH), or a physical sidelink shared channel (PSSCH).

Transmit processor 220 may process (e.g., encode and symbol map) the data and control information to obtain data symbols and control symbols, respectively. Transmit processor 220 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 230 may perform spatial processing (e.g., precoding) on the data symbols, the control symbols, and/or the reference symbols, if applicable, and may provide output symbol streams to the modulators (MODs) in transceivers 232a-232t. Each modulator in transceivers 232a-232t may process a respective output symbol stream (e.g., for OFDM) to obtain an output sample stream. Each modulator may further process (e.g., convert to analog, amplify, filter, and upconvert) the output sample stream to obtain a downlink signal. Downlink signals from the modulators in transceivers 232a-232t may be transmitted via the antennas 234a-234t, respectively.

At UE 104, antennas 252a-252r may receive the downlink signals from the BS 102 and may provide received signals to the demodulators (DEMODs) in transceivers 254a-254r, respectively. Each demodulator in transceivers 254a-254r may condition (e.g., filter, amplify, downconvert, and digitize) a respective received signal to obtain input samples. Each demodulator may further process the input samples (e.g., for OFDM) to obtain received symbols.

MIMO detector 256 may obtain received symbols from all the demodulators in transceivers 254a-254r, perform MIMO detection on the received symbols if applicable, and provide detected symbols. Receive processor 258 may process (e.g., demodulate, deinterleave, and decode) the detected symbols, provide decoded data for the UE 104 to a data sink 260, and provide decoded control information to a controller/processor 280.

On the uplink, at UE 104, transmit processor 264 may receive and process data (e.g., for the physical uplink shared channel (PUSCH)) from a data source 262 and control information (e.g., for the physical uplink control channel (PUCCH) from the controller/processor 280. Transmit processor 264 may also generate reference symbols for a reference signal (e.g., for the sounding reference signal (SRS)). The symbols from the transmit processor 264 may be precoded by a TX MIMO processor 266 if applicable, further processed by the modulators in transceivers 254a-254r (e.g., for SC-FDM), and transmitted to BS 102.

At BS 102, the uplink signals from UE 104 may be received by antennas 234a-t, processed by the demodulators in transceivers 232a-232t, detected by a MIMO detector 236 if applicable, and further processed by a receive processor 238 to obtain decoded data and control information sent by UE 104. Receive processor 238 may provide the decoded data to a data sink 239 and the decoded control information to the controller/processor 240.

Memories 242 and 282 may store data and program codes for BS 102 and UE 104, respectively.

Scheduler 244 may schedule UEs for data transmission on the downlink and/or uplink.

5G may utilize orthogonal frequency division multiplexing (OFDM) with a cyclic prefix (CP) on the uplink and downlink. 5G may also support half-duplex operation using time division duplexing (TDD). OFDM and single-carrier frequency division multiplexing (SC-FDM) partition the system bandwidth into multiple orthogonal subcarriers, which are also commonly referred to as tones and bins. Each subcarrier may be modulated with data. Modulation symbols may be sent in the frequency domain with OFDM and in the time domain with SC-FDM. The spacing between adjacent subcarriers may be fixed, and the total number of subcarriers may be dependent on the system bandwidth. The minimum resource allocation, called a resource block (RB), may be 12 consecutive subcarriers in some examples. The system bandwidth may also be partitioned into subbands. For example, a subband may cover multiple RBs. NR may support a base subcarrier spacing (SCS) of 15 KHz and other SCS may be defined with respect to the base SCS (e.g., 30 kHz, 60 kHz, 120 kHz, 240 kHz, and others).

As above, FIGS. 3A, 3B, 3C, and 3D depict various example aspects of data structures for a wireless communication network, such as wireless communication network 100 of FIG. 1.

In various aspects, the 5G frame structure may be frequency division duplex (FDD), in which for a particular set of subcarriers (carrier system bandwidth), subframes within the set of subcarriers are dedicated for either DL or UL. 5G frame structures may also be time division duplex (TDD), in which for a particular set of subcarriers (carrier system bandwidth), subframes within the set of subcarriers are dedicated for both DL and UL. In the examples provided by FIGS. 3A and 3C, the 5G frame structure is assumed to be TDD, with subframe 4 being configured with slot format 28 (with mostly DL), where D is DL, U is UL, and X is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description below applies also to a 5G frame structure that is TDD.

Other wireless communication technologies may have a different frame structure and/or different channels. A frame (10 ms) may be divided into 10 equally sized subframes (1 ms). Each subframe may include one or more time slots. Subframes may also include mini-slots, which may include 7, 4, or 2 symbols. In some examples, each slot may include 7 or 14 symbols, depending on the slot configuration.

For example, for slot configuration 0, each slot may include 14 symbols, and for slot configuration 1, each slot may include 7 symbols. The symbols on DL may be cyclic prefix (CP) OFDM (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission).

The number of slots within a subframe is based on the slot configuration and the numerology. For slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology u, there are 14 symbols/slot and 2μ slots/subframe. The subcarrier spacing and symbol length/duration are a function of the numerology. The subcarrier spacing may be equal to 2^{μ}×15 kHz, where u is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 3A, 3B, 3C, and 3D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 3A, some of the REs carry reference (pilot) signals (RS) for a UE (e.g., UE 104 of FIGS. 1 and 2). The RS may include demodulation RS (DM-RS) (indicated as Rx for one particular configuration, where 100x is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 3B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol.

A primary synchronization signal (PSS) may be within symbol 2 of particular subframes of a frame. The PSS is used by a UE (e.g., 104 of FIGS. 1 and 2) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 3C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 3D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Additional Considerations

The preceding description provides examples of adaptive CSI report deactivation for beam prediction in communication systems. The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The techniques described herein may be used for various wireless communication technologies, such as 5G (e.g., 5G NR), 3GPP Long Term Evolution (LTE), LTE-Advanced (LTE-A), code division multiple access (CDMA), time division multiple access (TDMA), frequency division multiple access (FDMA), orthogonal frequency division multiple access (OFDMA), single-carrier frequency division multiple access (SC-FDMA), time division synchronous code division multiple access (TD-SCDMA), and other networks. The terms “network” and “system” are often used interchangeably. A CDMA network may implement a radio technology such as Universal Terrestrial Radio Access (UTRA), cdma2000, and others. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as NR (e.g. 5G RA), Evolved UTRA (E-UTRA), Ultra Mobile Broadband (UMB), IEEE 802.11 (Wi-Fi), IEEE 802.16 (WiMAX), IEEE 802.20, Flash-OFDMA, and others. UTRA and E-UTRA are part of Universal Mobile Telecommunication System (UMTS). LTE and LTE-A are releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). NR is an emerging wireless communications technology under development.

The various illustrative logical blocks, modules and circuits described in connection with the present disclosure may be implemented or performed with a general purpose processor, a DSP, an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user equipment (see FIG. 1), a user interface (e.g., keypad, display, mouse, joystick, touchscreen, biometric sensor, proximity sensor, light emitting element, and others) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112 (f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. An apparatus for wireless communications, comprising:
a memory comprising instructions; and
one or more processors configured to execute the instructions and cause the apparatus to:
determine whether to deactivate a semi-persistent (SP) channel state information (CSI) report associated with a first CSI report setting that is linked with a CSI report associated with a second CSI report setting, wherein the second CSI report setting has a longer reporting periodicity than the first CSI report setting; and
deactivate the SP CSI report, when at least the CSI report associated with the second CSI report setting is active.

2. The apparatus of claim 1, wherein the SP CSI report associated with the first CSI report setting is a medium access control (MAC) control element (CE) activated CSI report or a downlink control information (DCI) triggered CSI report.

3. The apparatus of claim 1, wherein the deactivation of the SP CSI report is independent of a medium access control (MAC) control element (CE) or a downlink control information (DCI).

4. The apparatus of claim 1, wherein the SP CSI report associated with the first CSI report setting is deactivated based on a value of a CSI report timer associated with the first CSI report setting.

5. The apparatus of claim 4, wherein the value of the CSI report timer is radio resource control (RRC) preconfigured.

6. The apparatus of claim 4, wherein one or more values of the CSI report timer are radio resource control (RRC) preconfigured, and wherein a medium access control (MAC) control element (CE) activating the SP CSI report on a physical uplink control channel (PUCCH) indicates one of the one or more values.

7. The apparatus of claim 4, wherein one or more values of the CSI report timer are radio resource control (RRC) preconfigured, and wherein an uplink (UL) grant downlink control information (DCI) activating the SP CSI report on a physical uplink shared channel (PUSCH) indicates one of the one or more values.

8. The apparatus of claim 1, wherein the SP CSI report associated with the first CSI report setting is deactivated based on a value of a CSI report timer associated with the first CSI report setting and the second CSI report setting.

9. The apparatus of claim 8, wherein the value of the CSI report timer is radio resource control (RRC) preconfigured.

10. The apparatus of claim 8, wherein one or more values of the CSI report timer are radio resource control (RRC) preconfigured, and wherein a medium access control (MAC) control element (CE) activating the SP CSI report on a physical uplink control channel (PUCCH) indicates one of the one or more values.

11. The apparatus of claim 8, wherein one or more values of the CSI report timer are radio resource control (RRC) preconfigured, and wherein an uplink (UL) grant downlink control information (DCI) activating the SP CSI report on a physical uplink shared channel (PUSCH) indicates one of the one or more values.

12. The apparatus of claim 8, wherein one or more values of the CSI report timer are associated with the second CSI report setting.

13. The apparatus of claim 1, wherein the one or more processors are further configured to cause the apparatus to: determine that an uplink (UL) grant downlink control information (DCI) activating the SP CSI report on a physical uplink shared channel (PUSCH) further activates a configured grant (CG) PUSCH.

14. The apparatus of claim 13, wherein:
a starting and ending SP CSI report slot is same as a the CG PUSCH starting and ending slot, determined based on a CG time associated with the CG PUSCH; and
the CG PUSCH has an identical periodicity and a slot-offset as the first CSI report setting.

15. The apparatus of claim 1, wherein the one or more processors are further configured to cause the apparatus to: determine a first reporting slot for the SP CSI report, based on periodicities associated with the first CSI report setting and the second CSI report setting.

16. The apparatus of claim 1, wherein the one or more processors are further configured to cause the apparatus to:
determine a last transmission occasion for the SP CSI report based at least on the second CSI report setting, wherein the last transmission occasion for the SP CSI report is determined based on at least one of:
a last slot at least does not overlap or is not after a slot comprising a next applicable transmission occasion for the CSI report associated with the second CSI report setting; or
the last slot is determined based on radio resource control (RRC) configurations associated with a certain transmission occasion of the CSI report associated with the second CSI report setting; and
determine to refrain from output for transmission the SP CSI report in a certain slot, based at least on the slot comprises the CSI report associated with the second CSI report setting.

17. The apparatus of claim 1, wherein a priority of the SP CSI report being deactivated is either higher or lower than a priority of one or more of: periodic CSI reports, other SP CSI reports, and aperiodic CSI reports.

18. The apparatus of claim 1, wherein the one or more processors are further configured to cause the apparatus to: execute an SP CSI report procedure when a first SP CSI report is triggered, if at least a second SP CSI report is not triggered or released via a radio resource control (RRC).

19. The apparatus of claim 1, further comprising a transceiver configured to receive a medium access control (MAC) control element (CE) activating the SP CSI report or a downlink control information (DCI) triggering the SP CSI report, wherein the apparatus is configured as a user equipment (UE).

20. An apparatus for wireless communications, comprising:
a memory comprising instructions; and
one or more processors configured to execute the instructions and cause the apparatus to:
detect an uplink (UL) grant downlink control information (DCI) triggering an aperiodic channel state information (CSI) report and activating a configured grant (CG) physical uplink shared channel (PUSCH); and
sequentially output for transmission the aperiodic CSI report over multiple CG PUSCH transmission occasions, when at least one of a plurality of conditions is met.

21. The apparatus of claim 20, wherein the plurality of conditions comprise at least one of:
a first condition indicating that the aperiodic CSI report is associated with a first CSI report setting that is linked with a CSI report associated with a second CSI report setting,
a second condition indicating that the aperiodic CSI report is associated with the CG PUSCH,
a third condition indicating that the second CSI report setting is associated with the CG PUSCH, and
a fourth condition indicating that a reporting periodicity of the CG PUSCH is less than a reporting periodicity of the second CSI report setting.

22. The apparatus of claim 21, wherein the one or more processors are further configured to cause the apparatus to: obtain signaling comprising the UL grant DCI, when the CSI report associated with the second CSI report setting is active.

23. The apparatus of claim 20, wherein the CG PUSCH transmission occasions for reporting the aperiodic CSI report are determined based on a CG PUSCH timer associated with the CG PUSCH.

24. The apparatus of claim 20, wherein the aperiodic CSI report is based on one or more radio resource control (RRC) configurations linking at least one of a plurality of sub-configurations, wherein the plurality of sub-configurations comprise a first CSI report setting associated with the aperiodic CSI report, a second CSI report setting associated with a CSI report comprising a persistent or semi-persistent (SP) CSI report, and the CG PUSCH activated by the UL grant DCI.

25. The apparatus of claim 20, wherein the one or more processors are further configured to cause the apparatus to: execute an aperiodic CSI report procedure when a first aperiodic CSI report is triggered, if at least a second aperiodic CSI report is not triggered or released via a radio resource control (RRC).

26. The apparatus of claim 20, further comprising a transceiver configured to transmit the aperiodic CSI report, wherein the apparatus is configured as a user equipment (UE).

27. A method for wireless communications at a user equipment (UE), comprising:
determining whether to deactivate a semi-persistent (SP) channel state information (CSI) report associated with a first CSI report setting that is linked with a CSI report associated with a second CSI report setting, wherein the second CSI report setting has a longer reporting periodicity than the first CSI report setting; and
deactivating the SP CSI report, when at least the CSI report associated with the second CSI report setting is active.

28. The method of claim 27, wherein the SP CSI report associated with the first CSI report setting is a medium access control (MAC) control element (CE) activated CSI report or a downlink control information (DCI) triggered CSI report.

29. A method for wireless communications at a user equipment (UE), comprising:
detecting an uplink (UL) grant downlink control information (DCI) triggering an aperiodic channel state information (CSI) report and activating a configured grant (CG) physical uplink shared channel (PUSCH); and
sequentially outputting for transmission the aperiodic CSI report over multiple CG PUSCH transmission occasions, when at least one of a plurality of conditions is met.

30. (canceled)
